(19) United States
(12) Patent Application Publication
(10) Pub. No.: US 2008/0133864 A1
(43) Pub. Date: Jun. 5, 2008

(54) APPARATUS, SYSTEM, AND METHOD FOR CACHING FULLY BUFFERED MEMORY

(76) Inventors: Jonathan Randall Hinkle, Raleigh, NC (US); Aaron Mitchell Richardson, Clemmons, NC (US); Ganesh Balakrishnan, Morrisville, NC (US)

Correspondence Address: KUNZLER & ASSOCIATES, 8 EAST BROADWAY, SUITE 600, SALT LAKE CITY, UT, 84111, US

(21) Appl. No.: 11/566,149

(22) Filed: Dec. 1, 2006

(51) Int. Cl. G06F 12/06

(52) U.S. Cl. 711/170; 711/118; 711/E12.084

(57) ABSTRACT

An apparatus, system, and method are disclosed for caching fully buffered memory (FBM) data. A circuit card is connected to an FBM socket that is configured to receive a FBM. An interface module communicates with a memory controller and at least one FBM via the FBM socket through a plurality of electrical interfaces. A cache controller apportions memory space in the cache memory between each FBM of the at least one FBM according to an apportionment policy. A cache memory transparently stores data from the at least one FBM and the memory controller and transparently provides the data to the memory controller. The cache controller manages coherency between the at least one FBM and the cache memory.

### BACKGROUND OF THE INVENTION

1. Field of the Invention

This invention relates to Fully Buffered Memory (FBM) and more particularly relates to caching FBM data.

2. Description of the Related Art

Personal Computers, laptop computers, servers, and the like often use FBM as their main memory. FBM includes Fully Buffered Dual In-line Memory Modules (FBDIMM), fully buffered Double Data Rate 3 Synchronous Dynamic Random Access Memory (DDR3 SDRAM), custom fully buffered memories, and similar buffered technologies. Using memory modules allows the amount memory to be configured after a computer's motherboard is manufactured. For example, a computer manufacturer may add one or more FBM modules to a motherboard to configure the computer's memory capacity to a customer requirement.

Similarly, the use of FBM allows a user to upgrade a computer's memory. For example, the user may replace a one gigabyte (1 GB) FBM module with a two gigabyte (2 GB) FBM module to increase the computer's available memory. Alternatively, the user may add a second one gigabyte (1 GB) FBM module to the computer with a first one gigabyte (1 GB) FBM module to increase the computer's available memory.

FBM modules typically connect to FBM sockets and communicate with a memory controller over an electrical interface. The electrical interface may be a serial interface. As FBM modules are added to a computer, the latency for retrieving data from and storing data to each successively FBM module may increase.

For example, a first FBM module may have a first latency for retrieving data requested by the memory controller. A second FBM module that communicates with the memory controller through the first FBM module may have a significantly longer second latency for retrieving data requested by the memory controller. Similarly, a third FBM module communicating with the memory controller through the first and second FBM modules may a still longer third latency for retrieving data requested by the memory controller. As a result, the effectiveness of FBM modules added to a computer may be reduced.

### SUMMARY OF THE INVENTION

From the foregoing discussion, there is a need for an apparatus, system, and method that cache FBM data. Beneficially, such an apparatus, system, and method would reduce the latency for FBM data.

The present invention has been developed in response to the present state of the art, and in particular, in response to the problems and needs in the art that have not yet been fully solved by currently available systems for caching data. Accordingly, the present invention has been developed to provide an apparatus, system, and method for caching FBM data that overcome many or all of the above-discussed shortcomings in the art.

The apparatus to cache FBM data is provided with a module configured to functionally execute the steps of connecting a circuit card to an FBM socket, communicating with a memory controller and at least one FBM, transparently storing data, and managing coherency. The modules in the described embodiments include a circuit card, an interface module, a cache memory, and a cache controller.

The circuit card connects to an FBM socket that is configured to receive a FBM. In an embodiment, the circuit card connects to an FBM socket. In another embodiment, the FBM socket receives one or more FBM.

The interface module communicates with a memory controller and at least one FBM. The interface module may be a serial interface. In an embodiment, the interface module communicates with the memory controller and at least one FBM via the FBM socket through a plurality of electrical interfaces. The plurality of electrical interfaces may be serial interfaces.

The cache memory transparently stores the data from the at least one FBM and the memory controller. In an embodiment, the cache memory transparently provides the data to the memory controller. The cache memory may be a memory selected from dynamic random access memory (DRAM), static random access memory (SRAM), Flash memory, and magnetic random access memory.

The cache controller manages coherency between the at least one FBM and the cache memory. In an embodiment, the cache controller manages coherency using a write-back cache policy. In another embodiment, the cache controller manages coherency using a write-through cache policy.

The cache controller may apportion memory space in the cache memory between each FBM of the at least one FBM according to an apportionment policy. In an embodiment, the cache controller apportions memory space according to the apportionment policy in which the cache memory space is apportioned to FBM is in proportion to the number of electrical interfaces between the interface module and each FBM.

Additionally, the cache controller may manage the data stored in the cache memory. In an embodiment, the cache controller manages the data stored in the cache memory using an algorithm selected from a least recently used algorithm, a least frequently used algorithm, and a Belady's Min algorithm as is well known to those of skill in the art.

A system of the present invention is also presented to cache FBM data. The system may be embodied in a computer memory system. In particular, the system, in one embodiment, includes a memory controller, at least one FBM, and a circuit card.

The memory controller communicates with a plurality of electrical interfaces comprising FBM sockets that are configured to receive FBM. The at least one FBM is connected to at least one first FBM socket and communicates with the memory controller through at least one first electrical interface. The circuit card connects to a second FBM socket. The circuit card includes an interface module, a cache memory, and a cache controller.

The interface module communicates with the memory controller and the at least one FBM via the second FBM socket through the plurality of electrical interfaces. The interface module may be configured as a serial interface. In an embodiment, the plurality of electrical interfaces is serial interfaces. The cache memory transparently stores data from the at least one FBM and the memory controller and transparently provides the data to the memory controller. The cache memory may comprise memory selected from DRAM, SRAM, Flash memory, and magnetic random access memory. The cache controller manages coherency between the at least one FBM and the cache memory. The cache controller may also apportion memory space in the cache memory between each FBM of the at least one FBM according to an apportionment policy.

A method of the present invention is also presented for caching FBM data. The method in the disclosed embodiments substantially includes the steps to carry out the functions presented above with respect to the operation of the described apparatus and system. In one embodiment, the method includes connecting a circuit card to an FBM socket, communicating with a memory controller and at least one FBM, apportioning memory space in the cache memory, transparently storing and providing data, and managing coherency between the at least one FBM and the cache memory.

The circuit card connects to an FBM socket that receives a FBM. An interface module communicates with the memory controller and the at least one FBM via the FBM socket through a plurality of electrical interfaces. In an embodiment, the plurality of electrical interfaces is configured as serial interfaces. A cache controller apportions memory space in the cache memory between each FBM of the at least one FBM according to an apportionment policy. The cache memory transparently stores data from the at least one FBM and the memory controller and transparently provides the data to the memory controller. Additionally, the cache controller manages coherency between the at least one FBM and the cache memory. The cache controller may manage coherency using a write-back cache policy. Also, cache controller may manage coherency using a write-through cache policy.

In an additional embodiment, the cache controller manages the data stored in the cache memory. In an embodiment, the cache controller manages the data stored in the cache memory using a least recently used algorithm, or a least frequently used algorithm, or a Belady's Min algorithm.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention provides an apparatus, system and method that caches FBM data. Beneficially, the present invention may reduce latency of data delivered to a processor from FBM. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a schematic block diagram illustrating one embodiment of a main memory;

FIG. 1B is a schematic block diagram illustrating one embodiment of a system to cache fully buffered memory (FBM) data in accordance with the present invention;

FIG. 2 is a schematic block diagram illustrating one embodiment of an apparatus to cache FBM data of the present invention;

FIG. 3 is a perspective diagram illustrating one embodiment of a circuit card in accordance with the present invention; and

FIG. 4 is a schematic flow chart illustrating one embodiment of a caching FBM data method of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

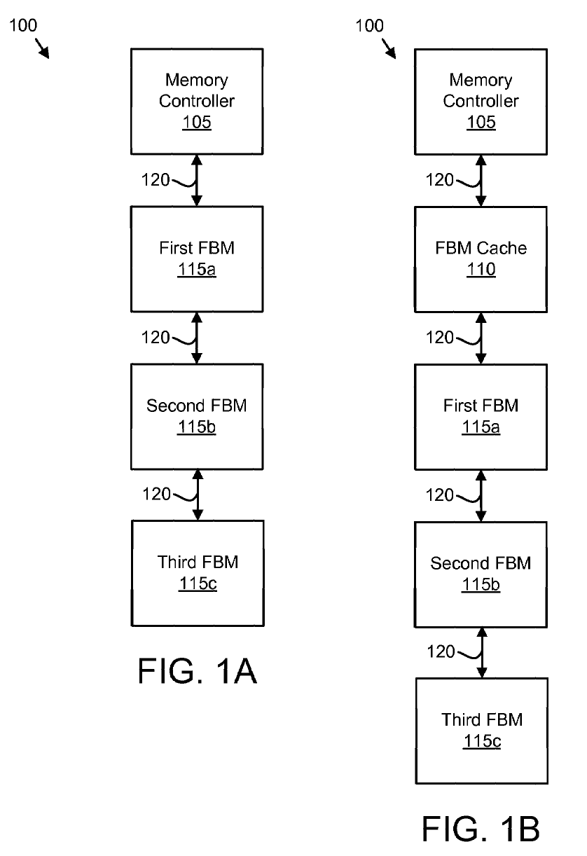

FIG. 1A is a schematic block diagram illustrating one embodiment of a main memory 100. The main memory 100 includes a memory controller 105 and one or more FBM cards 115. The main memory 100 may be part of a personal computer (PC), a server, a laptop computer, or the like referred to herein as PCs.

The most common PCs include a hard disk to permanently store data, the main memory 100, and a processor. The processor can only access data that is in main memory 100. To process data that resides in the hard disk, the CPU first transfers the data to main memory 100. The main memory 100 typically includes the memory controller 105 and one or more FBM 115. The use of FBM 115 allows the main memory to be configured after a PC motherboard is manufactured.

FBM 115 are typically connected to FBM sockets and communicate with the memory controller 105 over an electrical interface. The electrical interface may be a serial interface 120 as shown. Each electrical interface may include a FBM socket. As FBM 115 are added to a computer, the latency for retrieving data from and storing data to each successively FBM 115 may increase. A first FBM 115a may have a first latency for retrieving data requested by the memory controller 105. A second FBM 115b that communicates with the memory controller 105 through the first FBM 115b may have a significantly longer second latency for retrieving data requested by the memory controller. Similarly, a third FBM 115c communicating with the memory controller 105 through the first and second FBM modules 115a, 115b may a still longer third latency for retrieving data requested by the memory controller 105. As a result, the effectiveness of successive FBM 115 added to the PC may be reduced.

The memory controller 105 communicates with the plurality of electrical interfaces. The electrical For example, the memory controller 105 may communicate with a plurality of double data rate two (DDR2) serial interfaces 120. In an embodiment, the FBM sockets receive FBM 115. In an alternate embodiment, one or more serial interfaces 120 may receive one or more FBM 115.

An FBM 115 is connected to a FBM socket and communicates with the memory controller 105 through an electrical interface. For example, three (3) FBM 115 may be connected to three (3) FBM sockets and may communicate with the memory controller 105 through three (3) point-to-point electrical interfaces. More commonly, the electrical interfaces may be serial interfaces 120 as shown. Thus the memory controller 105 communicates with the third FBM 15c through the serial interfaces 120 and the first and second FBM 115a, 115b. The serial interfaces 120 may increase the latency for retrieving data from and storing data to each successively FBM 115.

FIG. 1B is a schematic block diagram illustrating one embodiment of a system 150 for caching FBM data in accordance with the present invention. The system 150 includes a FBM cache 110, the memory controller 105, and one or more FBM cards 115. The description of the system 150 refers to elements of FIG. 1A, like numbers referring to like elements.

The FBM cache 110 is connected to a FBM socket that is configured to receive a FBM 115. For example, the FBM cache 110 may be physically connected through the FBM socket by a daisy chain arrangement to the memory controller 105 and the FBM 115. In addition, one or more FBM sockets may receive one or more FBM 115a, 115b. The FBM 115a, 115b the FBM cache 110, and the FBM sockets may be a memory system of a computer, a communication device, and the like as is well known to those of skill in the art.

The FBM cache 110 caches data from the first, second, and third FBM 115 so that the data is available with the first latency from the FBM cache 110. As a result, the performance of the FBM 115 is improved as will be explained hereafter.

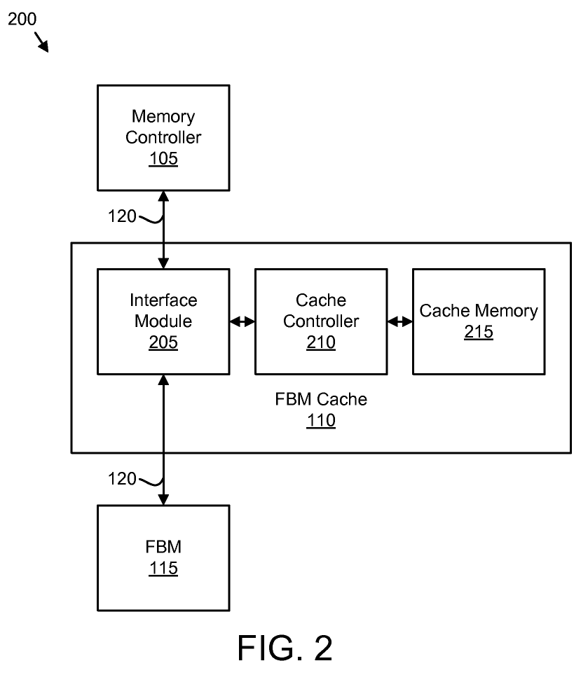

FIG. 2 depicts a schematic block diagram illustrating one embodiment of an apparatus 200 for caching FBM data. The apparatus 200 includes the memory controller 105, the at least one FBM 115, and the FBM cache 110 of FIG. 1B. The FBM cache 110 includes an interface module 205, a cache controller 210, and a cache memory 215.

The interface module 205 communicates with the memory controller 105 and the at least one FBM 115 via the FBM socket through a plurality of electrical interfaces. In the depicted embodiment, the interface module 205 is configured to communicate with the serial interface 120. For example, the interface module 205 may serially communicate with a memory controller 105 and the FBM 115 via a double data rate (DDR) serial interface 120. The communication may be automatic and bi-directional.

The cache memory 215 transparently stores the data from a FBM 115 and the memory controller 105. In another embodiment, the cache memory 215 transparently provides the data to the memory controller 105 in place of an FBM 115. For example, the cache memory 215 may transparently store data from the third FBM 115c and the memory controller 105 may access the stored data from the cache memory 215. The cache memory 215 may be a memory selected from DRAM, SRAM, Flash memory, and magnetic random access memory. For example, the cache memory 215 may be a DRAM of one gigabyte (1 GB).

The cache controller 210 manages coherency between the at least one FBM 115 and the cache memory 215. In an embodiment, the cache controller 210 manages coherency using a write-back cache policy. In another embodiment, the cache controller 210 manages coherency using a write-through cache policy.

The cache controller 210 may apportion memory space in the cache memory 215 between each FBM 115 according to an apportionment policy. In an embodiment, the apportionment policy apportions memory space to FBM 115 in proportion to the number of electrical interfaces between the interface module 205 and each FBM 115. For example, the apportionment policy may apportion memory space in the cache memory 215 using Equation 1, where pₙ is a proportion of the cache memory's memory space allocated to an nth FBM 115, n is the number of serial interfaces 120 between the nth FBM 115 and the interface module 205, and pₙ₋₁ is a proportion of an (n−1)th FBM such that the formula is true for all FBM 115.

pₙ=2pₙ₋₁ Equation 1

For example, if there 2 (two) FBM 115a, 115b the cache controller 210 may apportion one third (⅓) of the memory space in the cache memory 215 to the first FBM 115a and two thirds (⅔) of the memory space to the second FBM. Thus p₂ is equal to 2p₁.

The cache controller 210 may manage the data stored in the cache memory 215 using an algorithm selected from a least recently used (LRU) algorithm, a least frequently used (LFU) algorithm, and a Belady's Min algorithm. For example, the cache controller 210 may manage the data stored in the cache memory 215 using the LRU algorithm for selecting a least recently used data block for discard from the cache memory 215. In this algorithm, the data blocks are given a priority in the order of reference to prepare a list of the data blocks in terms of the frequency of use. Upon each occurrence of reference, the newly referred data block is placed at the head of the list to shift the previous data blocks to lower priority levels. Then, the data block of the lowest priority level is picked up by the algorithm using an LRU array and is stored with a data block of the main memory 100.

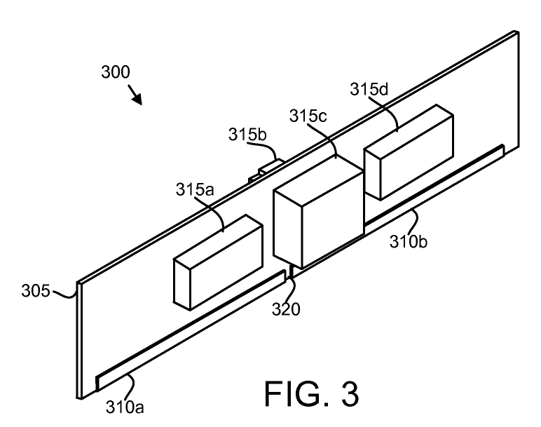

FIG. 3 is a perspective diagram illustrating one embodiment of a circuit card 300 in accordance with the present invention. The circuit card 300 may embody the FBM cache 110 of FIGS. 1B and 2. The description of the circuit card 300 refers to elements of FIGS. 1-2, like numbers referring to like elements. The circuit card 300 includes a printed circuit board 305, one or more edge card connectors 310, one or more electronic components 315, and a polarizing slot 320.

The edge card connectors 310 and the polarizing slot 320 are configured to connect to a FBM socket as is well known to those of skill in the art. The printed circuit board 305 may electrically connect the electrical components 315 to each other and to the edge card connectors 310 through metal traces disposed between one or more layers of the printed circuit board 305. The electrical components 315 embody the interface module 205, the cache controller 210, and the cache memory 215. For example, first and fourth electrical components 315a, 315d may embody the cache memory 215. In addition, a third electrical component 315c may embody the cache controller 210. A second electrical component 315b may embody the interface module 205.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

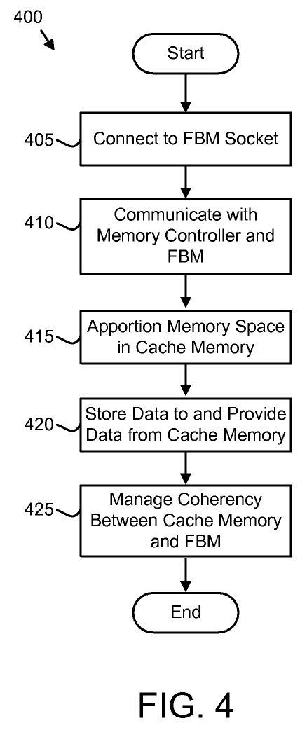

FIG. 4 is a schematic flow chart illustrating one embodiment of a method 400 for caching FBM data. The method 400 substantially includes the steps to carry out the functions presented above with respect to the operation of the described apparatus and system. The description of the method 400 refers to elements of FIGS. 1-3, like numbers referring to the like elements.

The method 400 begins, and in one embodiment, a circuit card 305 connects 405 to an FBM socket that receives a FBM 115. The interface module 205 communicates 410 with memory controller 105 and at least one FBM 115 via the FBM socket through a plurality of serial interfaces 120. For example, the interface module 205 may receive data and commands communicated between the memory controller 105 and the first, second, and third FBM 115a, 115b, 115c. In addition, the interface module 205 may communicate data to the memory controller 105 and/or the first, second, and third FBM 115a, 115b, 115c.

The cache controller 210 apportions 415 memory space in the cache memory 215 between each FBM 115 of the at least one FBM 115 according to an apportionment policy. In an embodiment, the apportionment policy apportions 415 memory space to FBM 115 in proportion to the number of electrical interfaces 120 between the interface module 205 and each FBM 115. In an alternate embodiment, the cache controller 210 apportions 415 memory space to FBM 115 using a table that specifies the memory space allocation for each FBM 115 of a given number of FBM 115.

The cache memory 215 transparently stores 420 data from the at least one FBM 115 and the memory controller 105. For example, if the memory controller 105 stores specified data to the first FBM 115a and there is a hit for the specified data in the first FBM 115a, the cache controller 210 may store 420 the specified data in the first proportion of the cache memory 215. As used herein a hit refers to valid data from an FBM 115 being present in the cache memory 215. In another example, if the specified data is directed to the second FBM 115b and there is a hit for the specified data in the second FBM cache memory 115b, the cache controller 210 may store the specified data in the second proportion of the cache memory 215.

In another embodiment, the cache memory 215 transparently provides 420 the data to the memory controller 105. For example, on receiving a read command from the processor to retrieve the specified data from the second FBM 115b, the cache memory 215 may provide 420 the specified data if the specified data yields a hit in any proportion of the cache memory 215. The hit indicates the specified data is stored in the cache memory 215. In one embodiment, the cache controller 210 tracks the data stored in the cache memory 215 so that cache hits may be determined as is well known to those of skill in the art.

The cache controller 210 manages 425 coherency between the at least one FBM 115 and the cache memory 215. For example, when the cache memory 215 supplies data to the processor in place of the FBM 115, there must be coherency between the cache memories 215 and the FBM 115. The cache controller 210 may manage 425 coherency between the FBM 115 and the cache memory 215 using a write-back cache policy. In the write back policy, the cache controller 210 may mark a portion of the cache memory 215 as ‘dirty’ once the cache memory′ data has been altered. When the cache memory 215 is full and a portion of the data in the cache memory 215 needs to be evicted, the data stored in the marked portion is written back to FBM 115. If the FBM 115 holds the same copy of the data, the cache memory 215 may discard the data as directed the cache controller 210.

In an additional embodiment, the cache controller 210 may manage the data stored in the cache memory 215 using an algorithm selected from a LRU algorithm, a LFU algorithm, and a Belady's Min algorithm. For example, the cache controller 210 may automatically manage the data stored in the cache memory 215 using the Belady's Min algorithm by simulating a future demand for data and caching the data with the highest demand as is well known to those of skill in the art.

The present invention provides an apparatus, system and method that caches FBM data. Beneficially, the present invention may reduce latency of data delivered to a processor from FBM. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to cache fully buffered memory (FBM) data, the apparatus comprising:
a circuit card configured to connect to an FBM socket that is configured to receive a FBM;
an interface module configured to communicate with a memory controller and at least one FBM via the FBM socket through a plurality of electrical interfaces;
a cache memory configured to transparently store data from the at least one FBM and the memory controller and transparently provide the data to the memory controller; and
a cache controller configured to manage coherency between the at least one FBM and the cache memory.

2. The apparatus of claim 1, the cache controller further configured to apportion memory space in the cache memory between each FBM of the at least one FBM according to an apportionment policy.

3. The apparatus of claim 2, wherein the apportionment policy apportions memory space to FBM in proportion to the number of electrical interfaces between the interface module and each FBM.

4. The apparatus of claim 3, wherein the apportionment policy apportions memory space using the equation pₙ=2pₙ₋₁ where pₙ is a proportion of the cache memory's memory space allocated to an nth FBM where n is the number of electrical interfaces between the nth FBM and the interface module and pₙ₋₁ is a proportion of an (n−1)th FBM such that the equation is true for all FBM.

5. The apparatus of claim 1, wherein the cache controller manages coherency using a write-back cache policy.

6. The apparatus of claim 1, wherein the cache controller manages coherency using a write-through cache policy.

7. The apparatus of claim 1, wherein the cache controller manages the data stored in the cache memory using an algorithm selected from a least recently used algorithm, a least frequently used algorithm, and a Belady's Min algorithm.

8. The apparatus of claim 1, wherein the interface module is configured to communicate with a serial interface and the plurality of electrical interfaces are serial interfaces.

9. The apparatus of claim 1, where in the cache memory comprises memory selected from dynamic random access memory, static random access memory, Flash memory, and magnetic random access memory.

10. A system to cache FBM data, the system comprising:
a memory controller in communication with a plurality of electrical interfaces comprising FBM sockets that are configured to receive FBM;
at least one FBM connected to at least one first FBM socket and in communication with the memory controller through at least one electrical interface;
a circuit card configured to connect to a second FBM socket and comprising
an interface module configured to communicate with the memory controller and the at least one FBM via the second FBM socket through the plurality of electrical interfaces;
a cache memory configured to transparently store data from the at least one FBM and the memory controller and transparently provide the data to the memory controller; and
a cache controller configured to manage coherency between the at least one FBM and the cache memory.

11. The system of claim 10, the cache controller further configured to apportion memory space in the cache memory between each FBM of the at least one FBM according to an apportionment policy.

12. The system of claim 10, wherein the interface module is configured to communicate with a serial interface and the plurality of electrical interfaces are serial interfaces.

13. The system of claim 10, where in the cache memory comprises memory selected from dynamic random access memory, static random access memory, Flash memory, and magnetic random access memory.

14. A method for caching FBM data, the method comprising:
connecting a circuit card to an FBM socket that is configured to receive a FBM;
communicating with a memory controller and at least one FBM via the FBM socket through a plurality of electrical interfaces;
apportioning memory space in the cache memory between each FBM of the at least one FBM according to an apportionment policy;
transparently storing data from the at least one FBM and the memory controller and transparently providing the data to the memory controller; and
managing coherency between the at least one FBM and the cache memory.

15. The method of claim 14, wherein the apportionment policy apportions memory space to FBM in proportion to the number of electrical interfaces between the interface module and each FBM.

16. The method of claim 15, wherein the apportionment policy apportions memory space using the equation pₙ=2pₙ₋₁ where pₙ is a proportion of the cache memory's memory space allocated to an nth FBM where n is the number of electrical interfaces between the nth FBM and the interface module and pₙ₋₁ is a proportion of an (n−1)th FBM such that the equation is true for all FBM.

17. The method of claim 14, wherein the plurality of electrical interfaces is configured as serial interfaces.

18. The method of claim 14, wherein the coherency is managed using a write-back cache policy.

19. The method of claim 14, wherein the coherency is managed using a write-through cache policy.

20. The method of claim 14, wherein the data stored in the cache memory is managed using an algorithm selected from a least recently used algorithm, a least frequently used algorithm, and a Belady's Min algorithm.
